(19) United States
(12) Patent Application Publication
(10) Pub. No.: US 2016/0048852 A1
(43) Pub. Date: Feb. 18, 2016

(54) PREDICTIVE RISK MANAGEMENT BASED PRODUCT PROCUREMENT

(71) Applicant: LENOVO ENTERPRISE SOLUTIONS (SINGAPORE) PTE. LTD., New Tech Park (SG)

(72) Inventors: Yong Ling Beh, Singapore (SG); Eric T. Gamble, Raleigh, NC (US); Kristian Slamet, Singapore (SG); Eric A. Stegner, Durham, NC (US); Julian S.K. Tan, Singapore (SG)

(21) Appl. No.: 14/459,197

(22) Filed: Aug. 13, 2014

(51) Int. Cl. G06Q 30/02; G06Q 50/00

(52) U.S. Cl. CPC G06Q 30/0202; G06Q 30/0206; G06Q 50/01

(57) ABSTRACT

An apparatus includes a demand module that determines a demand for a product offered from a plurality of suppliers. A pricing module receives cost factors associated with the product to determine a base per unit cost of the product. A quality module receives quality factors associated with the product to determine a per unit quality cost adder. A cost module calculates a procurement cost of the product. A supplier module receives production factors describing a supplier's ability to provide the product. A social module monitors social media for social data describing events related to a supplier's ability to provide the product. A procurement module determines, based on the per unit procurement cost of the product, the production factors, and the social data, a product order allocation for each supplier that fulfills the demand.

### FIELD

The subject matter disclosed herein relates to product procurement and more particularly relates to determining an order allocation for suppliers based on a total cost of procurement for a product.

### BACKGROUND

In general, procurement refers the acquisition of goods from an outside, external supplier. Typically, it is beneficial for purchasers to procure the goods at the best possible cost while also meeting the needs of the purchaser in terms of quality, quantity, time, location, etc. Often, procurement methods are based on demand forecasts and purchasers may place orders based on the lowest price quoted by suppliers. While this may be the simplest and easiest method for purchasers to determine which suppliers to order goods from, this procurement method fails to consider factors other than the price of the goods, which may ultimately increase the actual cost of the product.

### BRIEF SUMMARY

An apparatus for product procurement is disclosed. A method and computer program product also perform the functions of the method. The apparatus, in one embodiment, includes a demand module that determines a demand for a product offered from a plurality of suppliers. In some embodiments, the apparatus includes a pricing module that receives one or more cost factors associated with the product from each supplier of the plurality of suppliers. In certain embodiments, a base per unit cost of the product for each supplier is determined based on the one or more cost factors.

The apparatus, in one embodiment, includes a quality module that receives one or more quality factors associated with the product. The quality module, in some embodiments, determines a per unit quality cost adder for each supplier of the plurality of suppliers based on the one or more quality factors. The apparatus further includes a cost module that calculates a per unit procurement cost of the product for each supplier of the plurality of suppliers based on the base per unit cost and the per unit quality cost adder.

In one embodiment, the apparatus includes a supplier module that receives one or more production factors from each supplier of the plurality of suppliers. The production factors may describe a supplier's ability to provide the product. In one embodiment, the apparatus includes a social module that monitors one or more social media networks for social data describing one or more events related to a supplier's ability to provide the product. In certain embodiments, the apparatus includes a procurement module that determines, based on the per unit procurement cost of the product, the production factors, and the social data, a product order allocation for each supplier of the plurality of suppliers that fulfills the determined demand.

In one embodiment, the social module further subscribes to one or more rich site summary (RSS) feeds and monitors the one or more RSS feeds for events related to a supplier's ability to provide the product. In some embodiments, the social module further searches hashtag data associated with one or more social networks. The hashtag data may indicate events related to a supplier's ability to provide the product. In a further embodiment, the social module further receives social data related to a predefined geographic location associated with a supplier of the plurality of suppliers. The social data for the geographic location including information related to the supplier's ability to provide the product.

In certain embodiments, the social data includes information related to one or more events in the geographic location. In one embodiment, the one or more events include a natural disaster, a geopolitical unrest event, a military event, a terrorism event, and a financial crisis event. The geographic location may include a geographic location for a supplier's headquarters, shipper, distributor, assembly plant, manufacturing facility, and/or warehouse.

In one embodiment, the social module further uses a web crawler to search one or more websites for data including one or more customer ratings related to the product offered by the plurality of suppliers. In certain embodiments, the procurement module selects a supplier of the plurality of suppliers based at least in part on the customer ratings, which may include product ratings, warranty service ratings, customer service ratings, and/or customer satisfaction ratings. In some embodiments, the social module further uses a web crawler to search one or more websites of governmental organizations associated with the plurality of suppliers. In one embodiment, the social data includes regulatory information related to a supplier's ability to provide the product.

The apparatus, in a further embodiment, includes an update module that adjusts the determined product order allocation according to a customer's preference for one or more suppliers of the plurality of suppliers. In one embodiment, the apparatus includes an exclusion module that maintains a blacklist of one or more suppliers that are not granted an order allocation. In some embodiments, a supplier is blacklisted based on one or more factors associated with the supplier not being within a predetermined threshold related to supplying the product for a predefined period of time.

In one embodiment, the apparatus includes a history module that maintains one or more historical factors related to the plurality of suppliers. The procurement module, in some embodiments, determines a product order allocation based at least in part on the historical factors, which may be based on previous transactions with the plurality of suppliers. In some embodiments, the apparatus includes a trend module that determines trends for each of the cost factors, quality factors, production factors, and social data associated with each supplier of the plurality of suppliers. In some embodiments, the procurement module adjusts the product order allocation according to the trends. In one embodiment, the one or more quality factors include a number of customer complaints received for a product offered by a supplier of the plurality of suppliers. In certain embodiments, the procurement module adjusts the product order allocation in response to the number of customer complaints such that an allocation of products ordered from the supplier is reduced.

In one embodiment, the per unit quality cost adder for each supplier of the product is determined based on costs associated with returns, costs associated with warranties, costs associated with labor, costs associated with shipping, costs associated with insurance, and/or costs associated with product repair. In certain embodiments, the one or more production factors for each supplier of the plurality of suppliers includes a production yield, an order lead time, a manufacturing capacity, and/or a minimum order quantity.

A method for product procurement includes, in one embodiment, determining a demand for a product offered from a plurality of suppliers. In some embodiments, the method includes receiving one or more cost factors associated with the product from each supplier of the plurality of suppliers. In certain embodiments, a base per unit cost of the product for each supplier is determined based on the one or more cost factors.

The method, in one embodiment, includes receiving one or more quality factors associated with the product. The method, in some embodiments, determines a per unit quality cost adder for each supplier of the plurality of suppliers based on the one or more quality factors. The method further includes calculating a per unit procurement cost of the product for each supplier of the plurality of suppliers based on the base per unit cost and the per unit quality cost adder.

In one embodiment, the method includes receiving one or more production factors from each supplier of the plurality of suppliers. The production factors may describe a supplier's ability to provide the product. In one embodiment, the method includes monitoring one or more social media networks for social data describing one or more events related to a supplier's ability to provide the product. In certain embodiments, the method includes determining, based on the per unit procurement cost of the product, the production factors, and the social data, a product order allocation for each supplier of the plurality of suppliers that fulfills the determined demand.

The method, in one embodiment, includes receiving social data related to a predefined geographic location associated with a supplier of the plurality of suppliers. In some embodiments, the social data for the geographic location includes information related to the supplier's ability to provide the product. In one embodiment, the social data includes information related to one or more events in the geographic location, the one or more events including a natural disaster, a geopolitical unrest event, a military event, a terrorism event, and a financial crisis event.

In one embodiment, the method includes using a web crawler to search one or more websites for data including one or more customer ratings related to the product offered by the plurality of suppliers. In certain embodiments, the method selects a supplier of the plurality of suppliers based at least in part on the customer ratings. In one embodiment, the customer ratings include product ratings, warranty service ratings, customer service ratings, and/or customer satisfaction ratings.

A computer program product for product procurement is disclosed. The computer program product includes a computer readable storage medium having program instructions embodied therewith. The program instructions are readable/executable by a processor to cause the processor to determine a demand for a product offered from a plurality of suppliers. The program instructions are readable/executable by a processor to cause the processor to receive one or more cost factors associated with the product from each supplier of the plurality of suppliers. In certain embodiments, a base per unit cost of the product for each supplier is determined based on the one or more cost factors.

The program instructions are readable/executable by a processor to cause the processor to receive one or more quality factors associated with the product. The program instructions are readable/executable by a processor to cause the processor to determine a per unit quality cost adder for each supplier of the plurality of suppliers based on the one or more quality factors. The program instructions are readable/executable by a processor to cause the processor to calculate a per unit procurement cost of the product for each supplier of the plurality of suppliers based on the base per unit cost and the per unit quality cost adder.

The program instructions are readable/executable by a processor to cause the processor to receive one or more production factors from each supplier of the plurality of suppliers. The production factors may describe a supplier's ability to provide the product. The program instructions are readable/executable by a processor to cause the processor to monitor one or more social media networks for social data describing one or more events related to a supplier's ability to provide the product. The program instructions are readable/executable by a processor to cause the processor to determine, based on the per unit procurement cost of the product, the production factors, and the social data, a product order allocation for each supplier of the plurality of suppliers that fulfills the determined demand.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for product procurement in accordance with one embodiment of the present invention;

FIG. 2 is a schematic block diagram illustrating one embodiment of an apparatus for product procurement in accordance with one embodiment of the present invention;

FIG. 3 is a schematic block diagram illustrating another embodiment of an apparatus for product procurement in accordance with one embodiment of the present invention;

FIG. 4 is a schematic flow chart diagram illustrating one embodiment of a method for product procurement in accordance with one embodiment of the present invention; and

FIG. 5 is a schematic flow chart diagram illustrating another embodiment of a method for product procurement in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. The description of elements in each figure may refer to elements of proceeding figures. Like numbers refer to like elements in all figures, including alternate embodiments of like elements.

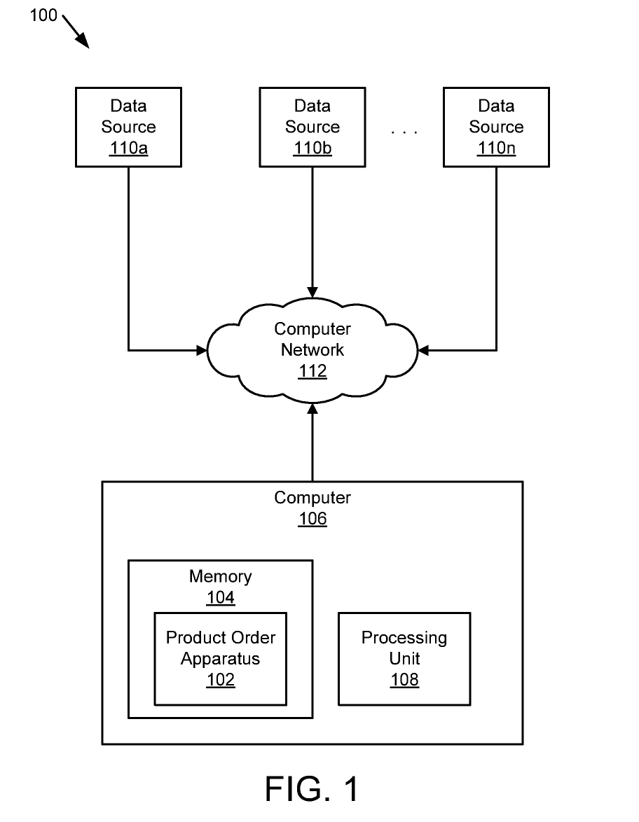

FIG. 1 is a schematic block diagram illustrating one embodiment of a system 100 for product procurement in accordance with one embodiment of the present invention. The system 100 includes a product order apparatus 102, memory 104, a computer 106, a processing unit 108, data sources 110a-n (collectively or individually “110”), and a computer network 112, which are described in more detail below.

The product order apparatus 102, in one embodiment, is configured to determine a total cost of a product offered from a plurality of suppliers and determine an order allocation schedule for the plurality of suppliers of the product such that demand for the product is fulfilled. In general, the product may be of the type that can be ordered in large volumes and may comprise a single component of another product. For example, the product may include computer components, such as hard disk drives, CD-ROM drives, motherboards, keyboards, touch screens, memory units, processors, and/or the like, that together function as a computer. In another example, the product may include automobile components, such as doors, windows, brakes, tires, gauges, tubes, or the like. The product may be associated with various industries, such as healthcare, transportation, construction, agriculture, livestock, or the like. One of skill in the art will recognize the variety of products that may be available to the product order apparatus 102.

In one embodiment, a product available from multiple suppliers is different for each supplier, but meets a common set of specifications and/or requirements. For example, if the product is a hard-disk drive, one supplier may provide a hard-disk drive that has a different architecture than another hard-disk drive while both hard-disk drives meet a common set of specifications. In another embodiment, the product may be substantially the same from different suppliers, but parts for the hard-disk drives may be from different suppliers. In another embodiment, the product may be the same from the various suppliers but are from different manufacturers. For example, if the product is a processor, each supplier may have a different manufacturer and the manufacturers may have differing quality standards and practices.

In general, the product order apparatus 102 determines a demand for a product and an order allocation among a plurality of suppliers to fulfill the product demand. In order to determine the order allocation, the product order apparatus, in one embodiment, determines a total cost of the product, including product and quality costs. Additionally, the product order apparatus 102, in some embodiments, considers secondary factors related to the product and/or a supplier that effect the supplier's ability to provide the product, the quality of the product, and/or the like. The secondary factors, in certain embodiments, may be based on social media data, such as posts related to the product on Facebook®, customer comments on Amazon®, hashtag data from Twitter®, or the like. For example, as described below in more detail, the product order apparatus 102 may determine that a supplier in China may not be able to supply the product based on a flood in the supplier's region, as indicated by multiple “#flood” hashtags on Twitter®. Similarly, the product order apparatus 102 may determine that a particular supplier should be blacklisted in response to receiving negative comments about the supplier's product quality from retail websites that sell the product, or similar products, provided by the supplier.

The system 100 may include memory 104 and, in one embodiment, the product order apparatus 102 is located in the memory 104. For example, the product order apparatus 102 may include executable code stored on one or more computer readable storage media. The memory may be random access memory (“RAM”), solid-state non-volatile memory, a hard disk drive (“HDD”), an optical drive, cloud storage, a storage area network (“SAN”), or other computer readable storage media capable of storing the product order apparatus 102. The memory 104 may reside in the computer 106 as depicted in FIG. 1 or may be external to the computer 106 and may be accessible to the computer 106. In various embodiments, the product order apparatus 102 may be together as depicted in FIG. 1 or may have some modules or portions in different locations.

The computer 106 may be a server, mainframe computer, a workstation, a desktop computer, a laptop computer or the like. The computer 106 is depicted as one device in FIG. 1, but may include other components, such as storage devices, one or more displays, or may be part of a distributed computing environment. In one embodiment, the computer 106 is a dedicated device configured specifically for the product order apparatus 102 and may include dedicated logic hardware, a field programmable logic array (“FPGA”), or the like. The computer 106 may include one or more processing units 108, such as a single processor, a multi-core processor, multiple processors on different motherboards, or the like. For example, the computer 106 may include a mainframe with multiple processors capable of executing multiple virtual machines. One of skill in the art will recognize other configurations of one or more computing devices and associated devices capable of incorporating the product order apparatus 102.

The system 100, in one embodiment, includes one or more data sources 110 accessible to the computer 106 over a computer network 112. The data sources 110 may include one or more computers, servers, computer readable storage devices, etc. The data sources 110 include information about a product from various suppliers where the information is available to the product order apparatus 102. In one embodiment, the computer network 112 includes the internet and the data sources 110 include one or more websites or other data storage locations accessible over the internet. The computer network 112 may also include a local area network (“LAN”), a wireless network such as a WiFi network, a storage area network (“SAN”), and the like. The data sources 110 may include one or more social networks, blogs, bulletin boards, government sponsored websites regarding recalls and compliance with standards, or the like, where regulators, customers, and suppliers communicate information about a component supplied by the suppliers.

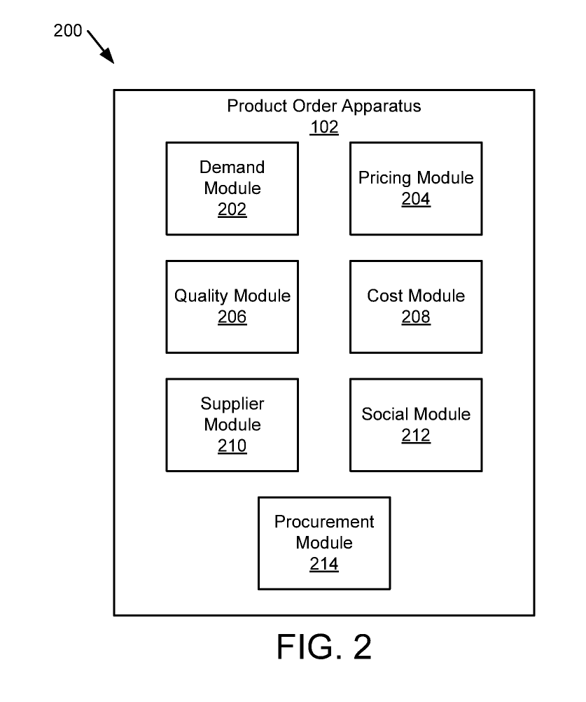

FIG. 2 is a schematic block diagram illustrating one embodiment of an apparatus 200 for product procurement in accordance with one embodiment of the present invention. The apparatus 200 includes one embodiment of a product order apparatus 102 with a demand module 202, a pricing module 204, a quality module 206, a cost module 208, a supplier module 210, a social module 212, and a procurement module 214, which are described in more detail below.

In one embodiment, the demand module 202 determines a demand for a product offered from a plurality of suppliers. As described above with reference to the FIG. 1, the product may include various types of products that typically may be purchased in lots, bulk sizes, or large volumes. The product may be a component that is integrated into a different product. The product may also be comprised of various components. For example, the product may include a computer processor that is integrated into a laptop computer and also includes various components, such as a plurality of transistors, or the like.

The suppliers, in certain embodiments, include entities that offer the product for sale, such as a manufacturer, a wholesaler, a retailer, or the like. In certain embodiments, the suppliers include one component of a supply chain for the product, which may include various entities, such as suppliers, manufacturers, assemblers, distributors, shippers, and/or the like. In some embodiments, the suppliers offer the same products, or substantially similar products, that meet specific product specifications. In some embodiments, the suppliers are located in various geographic regions, time zones, or the like.

The demand module 202, in some embodiments, determines demand for a product based on different factors. As used herein, demand refers to a quantity of product that is requested at a particular period of time. The demand module 202, in certain embodiments, determines demand based on historical data, such as previous order quantities for the product. In some embodiments, the demand module 202 determines demand based on a forecasted demand for the product. Additionally, the demand module 202 may also determine the demand for the product based on current inventory levels of the product. For example, if 500 units of a particular hard-disk drive (“HDD”) have been ordered each week for the past 12 weeks, the demand module 202 may determine that a new order of 500 HDDs should be ordered this week. However, if the forecasted demand for the product, or for a product that integrates the demanded product, declines, the demand module 202 may set demand at only 350 HDDs. Similarly, if the demand module 202 determines that there are currently 200 HDDs in inventory, the demand module 202 may set the demand at 300 units.

The pricing module 204, in one embodiment, receives one or more cost factors associated with the product from each supplier of the plurality of suppliers in order to determine a base per unit cost of the product for each supplier. In some embodiments, the cost factors include the base cost of the product as set by a supplier. In certain embodiments, the cost factors include incidental costs such as service fees, taxes, shipping and handling fees, or the like. In some embodiments, the cost factors include volume discounts that may be offered by a supplier. For example, supplier A may offer a HDD for a base price of $10 per unit and if 500 units are ordered, supplier A may discount the base price by 10%; if 1,000 units are ordered, supplier A may discount the base price by 20%; and so on.

The pricing module 204, in one embodiment, incorporates the various cost factors to determine a base per unit cost for each supplier that offers the product. Thus, for example, supplier A may offer a HDD for a base price of $80 with a 5% rebate and shipping costs of $2.00 per unit. The total cost for supplier A would be $78 per unit. Supplier B may offer the same, or substantially similar, HDD for a base price of $78 with a 7% rebate and shipping costs of $1.50 per unit. The total cost for supplier B would be $74.04 per unit. In this manner, the pricing module 204 determines a base price per unit for each supplier that offers the demanded product.

In one embodiment, the pricing module 204 receives cost information related to the product from the one or more suppliers. In one embodiment, the pricing module 204 sends requests for offers to the suppliers and receives price quotes for the product from the suppliers, including the base price costs, fees, and any discounts. In some embodiments, the pricing module 204 is in communication with a device associated with supplier that provides product and pricing information via the computer network 112. In some embodiments, if current cost information is not available to the pricing module 204, the pricing module 204 uses historical cost information (e.g., pricing information from a recent order associated with the supplier) to estimate a base price per unit for the product.

The quality module 206, in one embodiment, receives one or more quality factors associated with the product. In some embodiments, the quality factors are indicative of various costs associated with a quality of the product. In certain embodiments, based on the quality factors, the quality module 206 calculates or determines a per unit quality cost adder for each supplier of the product. The per unit quality cost adder may be added to, or incorporated with, the base cost per unit determined by the pricing module 204 to determine a total product cost.

In certain embodiments, the quality factors include variables external to the manufacturing process, i.e., field quality costs, such as costs associated with product returns, costs of labor, costs of warranties, or the like. In some embodiments, the quality factors include variables internal to the manufacturing process, such as costs associated with a high fallout resulting in lower production yields. Other quality costs may include carrying costs, product insurance costs, shipping costs, customer service costs, or the like. In further embodiments, the quality cost factors include logistical costs (e.g., shipping costs to send new processors), field labor costs (e.g., costs associated with sending personnel to repair or replace the processor), insurance costs, or the like. For example, it may cost $1.50 to process the returned product, $1.00 to ship a new product, $3.00 for labor to install the new product, and so on. Further, the quality cost factors associated with the poor quality of the processor may include increased administrative costs, such as costs associated with hiring more customer service personnel to handle customer complaints or reports.

In certain embodiments, the quality cost data is based on historical quality cost data. For example, if a particular processor provided by supplier A has had a large number of returns or warranty claims, which may indicate poor quality, the quality module 206 may determine one or more costs associated with the returns and warranties in order to derive a per unit quality cost adder. In this manner, the quality cost adder determined by the quality module 206, based on the various quality cost factors, provides an indication of the real cost of the product, in addition to the base price per unit for the product.

In one embodiment, the quality module 206 determines one or more qualitative factors associated with the quality of a supplier's products. The qualitative factors related to a product's quality may include customer complaints for the product received in a customer service center, customer survey results, feedback received from focus groups, and/or the like. For example, a customer service center may flag a particular product (from one or more suppliers) as an increasing number of return requests are received. The increasing number of calls requesting to return the product may signal a potential problem with the product. As such, the quality module 206 may indicate that the amount of the flagged product ordered from one or more suppliers should be reduced and/or cut-off. The quality module 206, based on the qualitative information, may provide trends, forecasts, or the like related to the quality of the product from the customer's point of view. In this manner, the quality module 206 may provide supplier recommendations, suggestions, or the like, in addition to determining a quantitative quality cost adder.

In one embodiment, the cost module 208 calculates a per unit procurement cost of the product for each supplier of the plurality of suppliers based on the base per unit cost and the per unit quality cost adder. For example, the cost module 208 may simply add the base per unit cost and the per unit quality cost adder to determine a total per unit procurement cost of the product. In another embodiment, the quality cost adder may be a percentage of the base cost per unit, a proportion of the base cost per unit, a ratio of the base cost per unit, or the like. In such an embodiment, the cost module 208 calculates the quality cost adder as a factor of the base cost to determine the total per unit procurement cost. In this manner, the cost module 208 provides an actual, end-to-end, total cost of the product, which may help determine which suppliers should be selected, how many products should be ordered from particular suppliers, or the like.

Continuing with the previous example above, the quality module 206 may determine that the quality cost adder for supplier A is $0.50 per HDD and the quality cost adder for supplier B is $6.12 per HDD. The cost module 208 may then determine that the total procurement cost of the product for supplier A is 78.50 ($76+$0.50) and the total procurement cost of the product for supplier B is $80.16 ($74.04+$6.12). Thus, without factoring in the quality cost factors, supplier B may have been selected based solely on the base cost of the HDDs per unit. However, by factoring in the quality cost factors, the product order apparatus determines that it would actually be less expensive to order HDDs from supplier A than from supplier B.

The supplier module 210, in one embodiment, receives one or more production factors from each supplier of the plurality of suppliers. In some embodiments, the one or more production factors describe a supplier's ability to provide the product. In certain embodiments, the production factors include supplier-specific factors that may affect whether the supplier can provide the product, how much of the product the supplier can supply, or the like, such as capacity constraints, order lead times, production yields, minimum/maximum order requirements, geographic considerations, and/or the like.

For example, the supplier module 210 may be in communication with supplier A (e.g., in communication with one or more devices associated with resources within supplier A's supply chain) in order to determine such factors as the capacity utilization of supplier A, which may indicate how many products supplier A can produce; the amount of lead time for production before an order is started or fulfilled; how many products supplier A can provide for a predetermined period of time; whether supplier A has a minimum or maximum order requirement; and the amount of time it takes to receive products from supplier A.

The supplier module 210, in certain embodiments, provides one or more supplier recommendations based on the production factors. For example, if supplier A has a lower lead time than supplier B, the supplier module 210 may recommend supplier A over supplier B. In some embodiments, the supplier module 210 recommends suppliers according to the preferences of the buyer (e.g., the procurement center of an organization, a procurement manager, etc.). For example, if the buyer prefers to order large quantities from a few suppliers as possible, the supplier module 210 may recommend supplier B over supplier A, assuming supplier B has a larger capacity utilization than supplier A, even though supplier A has a lower lead time than supplier B.

In one embodiment, the social module 212 monitors one or more social media networks for social data describing one or more events related to a supplier's ability to provide the product. As used herein, a social media network may include one or more websites that allow the creation and exchange of user-generated content. This may include social networking websites such as Facebook®, Instagram®, Twitter®, YouTube®, and/or the like. As used herein, social media may also include interactive websites and other online content such as blogs, websites that allow users to provide comments (e.g., such as by providing consumer reviews of a product), rich site summary (“RSS”) feeds, news websites, government websites, and/or the like.

In one embodiment, the social module 212 uses a web crawler to search one or more websites for social data related to the product and/or a product supplier. In certain embodiments, the social module 212 uses a web crawler to search websites for customer ratings related to the product. For example, the social module 212 may use a web crawler to search online retail sites, such as Amazon®, for customer comments, ratings, reviews, rankings, or the like, related to the product and/or a product supplier. In some embodiments, the customer ratings may be associated with the product, a product supplier, a supplier's warranty service, a supplier's customer service, and/or the like.

In certain embodiments, the social module 212 uses a web crawler to search one or more websites of governmental organizations associated with the plurality of suppliers. In certain embodiments, the social module 212 receives social data including regulatory information, such as new and existing laws, proposed legislation, public notices, court decisions, and/or the like that may affect a supplier's ability to provide the product. For example, the social module 212 may use a web crawler to search “www.usa.gov” for information from the government for the United States, “gov.cn” for information from the government for the People's Republic of China, or the like. The regulatory information that may affect a supplier's ability to provide the product may include regulations related to logistics, employment, taxes, the environment, and/or the like.

In one embodiment, the social module 212 subscribes to one or more RSS feeds to discover information for events related to a supplier's ability to provide the product. The social module 212, in a further embodiment, searches social media content and hashtag data associated with one or more social networks for indications of events related to a supplier's ability to provide the product. As used herein, hashtag data is a word or phrase prefixed with a number sign (“#”). In certain embodiments, the events that may affect the supplier's ability to provide the product include natural disasters, geopolitical unrest events, military events, terrorism events, financial crises, and/or the like.

For example, the social module 212 may subscribe to an RSS feed for a news website, such as FoxNews®, CNN®, or the like, to search for information related to the above-referenced events. In some embodiments, the social module 212 subscribes to blogs, or RSS feeds for the blogs, that may include information associated with the events. For example, the American Red Cross may maintain a blog that includes information related to disruptive events where the organization is currently involved. In some embodiments, the social module 212 monitors one or more social media sites for social media content and/or hashtag data indicating the occurrence of an event. For example, the social module 212 may monitor the Facebook® or Twitter® page for the Federal Emergency Management Agency (“FEMA”) for social media posts and/or hashtag data related to an emergency event.

The social module 212, in some embodiments, searches RSS feeds for keywords associated with events that may have an effect on a supplier's ability to provide the product. In certain embodiments, the social module 212 searches hashtag data from one or more social media sites, such as Facebook® or Twitter®, for keywords or phrases that may indicate the occurrence of an event. For example, the social module 212 may search an RSS feed for keywords associated with natural disasters, such as “flood,” “earthquake,” “fire,” “tsunami,” or the like. The social module 212 may also search hashtag data for keywords associated with political unrest or military actions, such as “#war,” “#tensions,” “#combat,” “#unrest,” “#riot,” “#terrorist,” or the like.

In certain embodiments, the social module 212 searches or parses the contents of RSS feeds, comments, posts, “tweets,” or the like, that are posted to social media sites. For example, a “tweet” may include content regarding an earthquake in a supplier's location, but may not include a particular hashtag. In such an example, the social module 212 may parse the “tweet” for specific keywords, such as “earthquake.” In some embodiments, the social module 212 performs natural language processing, or a different language processing method, to determine the context of social media content. In such an embodiment, the social module 212 may determine whether an event has occurred that could affect a supplier's ability to provide the product even though no keywords or hashtags may be recognized in the social media content.

In a further embodiment, the social module 212 searches RSS feeds, social media content, or hashtag data for keywords associated with suppliers, products, or the like. For example, the social module 212 may search customer reviews for a particular HDD on Amazon® for quality-related keywords, such as “poor,” “bad,” “do not buy,” or the like, which may indicate issues with the product specifically or with the supplier in general.

In one embodiment, the social module 212 receives social data related to a predefined geographic location associated with a supplier. In certain embodiments, the geographic location is associated with one or more resources within the supplier's supply chain, such as the supplier's headquarters, shipper, distributor, assembly plant, manufacturing facility, warehouse, or the like. For example, if supplier A is located in Thailand, the social module 212 may limit its social data search to social data related to Thailand. The social module 212 may first perform a keyword search for “Thailand” and then further refine its search to keywords related to events that may have occurred in that area. The social module 212, in some embodiments, bases its geographic search on social data received from previous searches. For example, if the social module 212 determines that there is a high occurrence of hashtags including the keyword “#thailand,” the social module 212 may further refine its search for events in Thailand.

Based on the received social data, the social module 212 may provide one or more recommendations about suppliers, products, or the like. For example, if the social module 212 finds that there is a large occurrence of “#flood” hashtags in a particular geographic area, the social module 212 may recommend that the procurement center avoid ordering any products from suppliers from that area. On the other hand, as another example, if the social module 212 determines that a product provided by a specific supplier is receiving high ratings in customer comments, the social module 212 may recommend ordering the product from that supplier.

The procurement module 214, in one embodiment, determines, based on the per unit procurement cost of the product, the production factors, and the social data, a product order allocation for each supplier of the plurality of suppliers that fulfills the determined demand. Initially, the procurement module 214 may determine an order allocation based on the per unit procurement cost for each supplier. Thus, if supplier A is the least expensive of all the suppliers of the product, the procurement module 214 may allocate 100% of the demand to supplier A.

However, supplier A may not have the capacity to fulfill 100% of the demand alone, as determined by the supplier module 210. Alternatively, the supplier module 210 may determine that supplier A has a longer lead time than other suppliers, which may exclude them from being selected if time is of the essence. Based on the supplier factors determined by the supplier module 210, the procurement module 214 may dynamically adjust the order allocation for each supplier. Thus, if supplier A only has capacity to fulfill 60% of the demand, the procurement module 214 may allocate the remaining 40% of the demand to supplier B.

Similarly, if the social module 212 determines that supplier A has not received positive customer reviews or that there is an event (e.g., a natural disaster) in supplier A's region, the procurement module 214 may not allocate any portion of the demand to supplier A. The procurement module 214 may, again, dynamically adjust the order allocation to account for the social data received by the social module 212. The procurement module 214, in response to determining an order allocation that fulfills the demand for the product, submits orders for the product with the selected suppliers.

In some embodiments, the procurement module 214 determines one or more order allocation schedules that each fulfill the demand for the product. For example, the procurement module 214 may prepare one order allocation based solely on procurement cost per unit, another order allocation incorporating the supplier factors, another order allocation incorporating the social data, and so on. The procurement module 214 may select a particular order allocation schedule based on user input in response to presenting the order allocation schedules to the user. In some embodiments, the procurement module 214 automatically selects an order allocation schedule based on one or more predetermined parameters. For example, a user may specify that the procurement module 214 should order from supplier X if the cost is below Y amount, or if the lead time is less than Z days, etc.

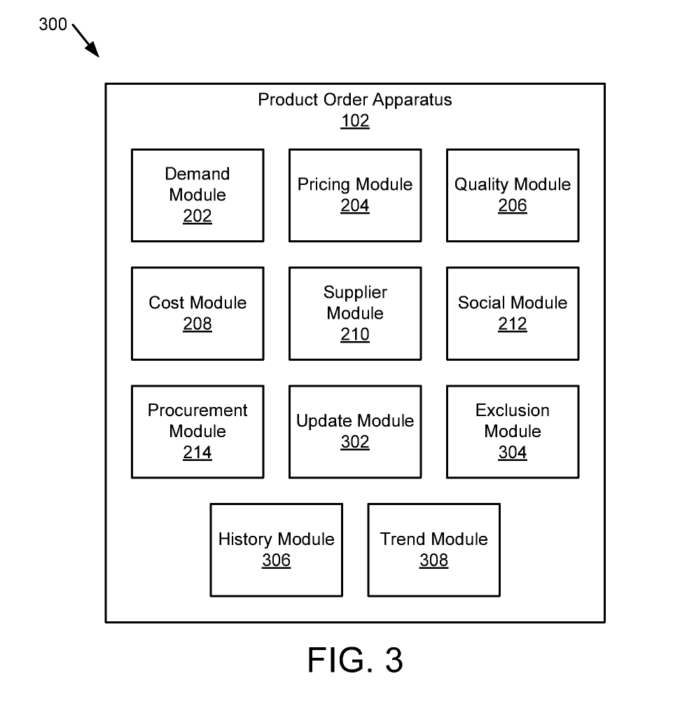

FIG. 3 is a schematic block diagram illustrating one embodiment of an apparatus 300 for product procurement in accordance with one embodiment of the present invention. The apparatus 300 includes one embodiment of a product order apparatus 102 with a demand module 202, a pricing module 204, a quality module 206, a cost module 208, a supplier module 210, a social module 212, and a procurement module 214, which may be substantially similar to the demand module 202, pricing module 204, quality module 206, cost module 208, supplier module 210, social module 212, and procurement module 214 described above with reference to FIG. 2. In certain embodiments, the product order apparatus 102 includes an update module 302, an exclusion module 304, a history module 306, and a trend module 308, which are described in more detail below.

The update module 302, in one embodiment, refreshes the cost factors, the quality factors, the production factors, and/or the social data. In certain embodiments, the update module 302 notifies the pricing module 204, the quality module 206, the supplier module 210, or the social module 212 to receive new information or data related to their respective factors. In some embodiments, the update module 302 updates the factors or data in real-time, according to a predetermined schedule, in response to user input, or the like.

In some embodiments, the update module 302 adjusts the product order allocation, as determine by the procurement module 214, according to a customer's preference for one or more suppliers. For example, the procurement module 214 may have determined that supplier A should fulfill 50% of the order and supplier B should fulfill the other 50% of the order. However, the update module 302 may adjust the order allocation by replacing supplier B with supplier C and increasing supplier's C allocation to 75% in response to the customer's preference for supplier C. Thus, in this example, the final order allocation would be 25% to supplier A and 75% to supplier C. The update module 302 may adjust the order allocation in response to user input from procurement managers, administrators, or the like.

In one embodiment, the exclusion module 304, maintains a blacklist of one or more suppliers that are not granted an order allocation because one or more factors associated with the supplier has not been within a predetermined threshold related to supplying the product for a predefined period of time. For example, if the number of returns for a product supplied by supplier A is above a predetermined amount for six months, then supplier A may be blacklisted until supplier A can resolve any issues. Similarly, if supplier B is consistently near full capacity, supplier B may be blacklisted until they can get their capacity to an acceptable level.

The history module 306, in one embodiment, maintains one or more historical factors related to the suppliers, such as special product or supplier considerations, previous supply issues (e.g., delays, warranty costs, high number of returns, etc.), ease to work with in the past, average lead time, average shipping time, or the like. The procurement module 214, based on the historical data, may update the determined order allocation. For example, the procurement module 214 may allocate 80% of the demand to supplier A; however, if supplier A has had a recent track-record of delaying delivery of their products, the procurement module 214 may update the order allocation to exclude supplier A. In another example, the procurement module 214 may select supplier B over supplier A if the history module 306 determines that supplier B has provided exceptional customer service in the past.

In one embodiment, the trend module 308 determines trends for each of the cost factors, quality factors, production factors, and social data associated with each supplier. As used herein, a trend describes a change in a general direction over time for a factor. Based on the trending data, the procurement module 214 may adjust the product order allocation. For example, if the number of returns for products produced by supplier A has steadily increased over the past twelve months, even though it may still be in an acceptable range, the procurement module 214 may exclude supplier A from the order allocation until the number of returns for supplier A stops trending upward. In like manner, if supplier B had a trending history of long lead times that caused the procurement module 214 to exclude supplier B from consideration, but now the lead time trend has been decreasing over the past six months, the procurement module 214 may again consider supplier B.

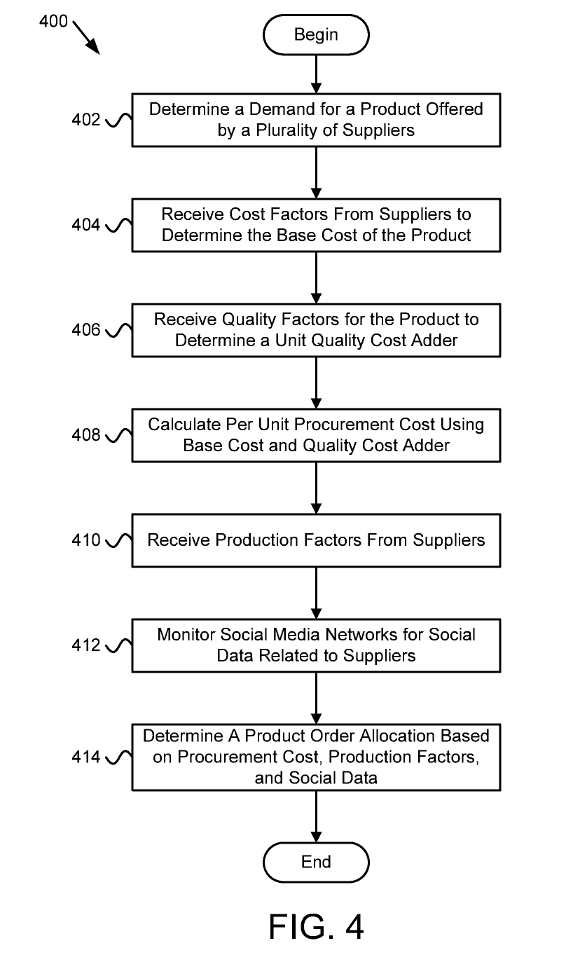

FIG. 4 depicts one embodiments of a method 400 for product procurement in accordance with the present invention. In one embodiment, the method 400 beings and the demand module 202 determines 402 a demand for a product offered from a plurality of suppliers. In some embodiments, the pricing module 204 receives 404 one or more cost factors associated with the product from each supplier of the plurality of suppliers in order to determine a base per unit cost of the product for each supplier. In certain embodiments, the quality module 206 receives 406 one or more quality factors associated with the product in order to determine a per unit quality price adder for each supplier.

In one embodiment, the cost module 208 calculates 408 a per unit procurement cost of the product for each supplier of the plurality of suppliers based on the base per unit cost and the per unit quality cost adder. The supplier module 210, in a further embodiment, receives 410 one or more production factors from each supplier of the plurality of suppliers that describe a supplier's ability to provide the product. In certain embodiments, the social module 212 monitors 412 one or more social media networks for social data describing one or more events related to a supplier's ability to provide the product. In one embodiment, the procurement module 214, determines 414, based on the per unit procurement cost of the product, the production factors, and the social data, a product order allocation for each supplier of the plurality of suppliers that fulfills the determined demand, and the method 400 ends.

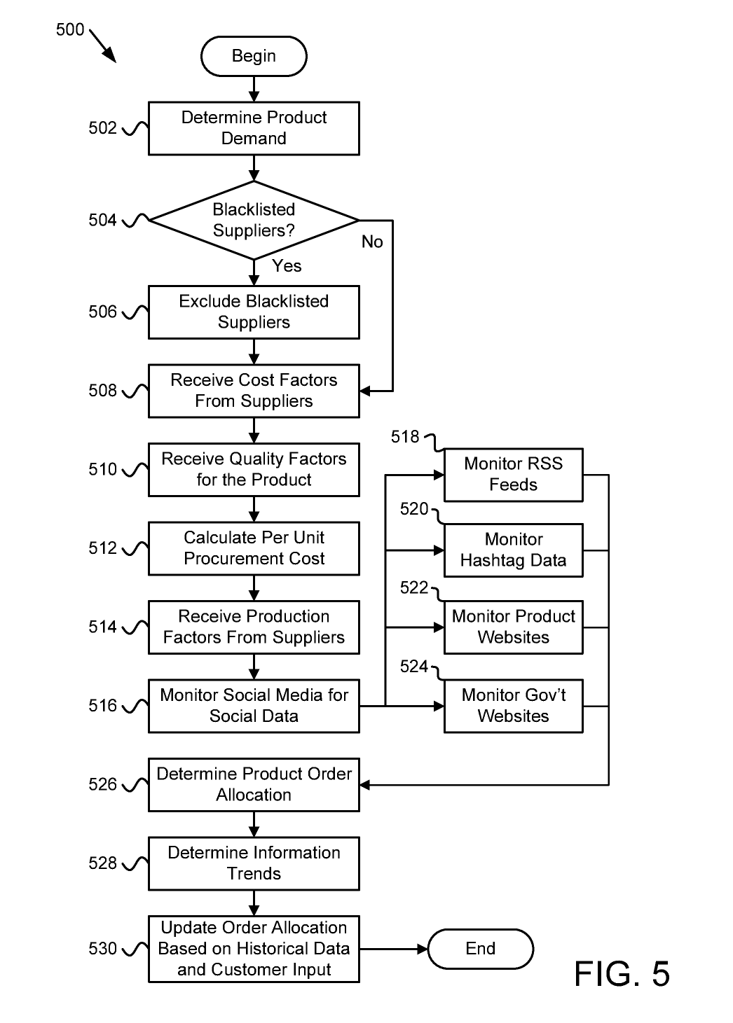

FIG. 5 depicts one embodiment of another method 500 for product procurement in accordance with the present invention. In one embodiment, the method 500 begins and the demand module 202 determines 502 a demand for a product offered from a plurality of suppliers. In certain embodiments, the exclusion module 304 determines 504 whether any of the possible suppliers of the product have been blacklisted, meaning that one or more factors associated with the supplier has not been within a predetermined threshold related to supplying the product for a predefined period of time. If the exclusion module 304 determines that a supplier has been blacklisted, the exclusion module 304 excludes 506 the blacklisted supplier form consideration.

In some embodiments, the pricing module 204 receives 508 one or more cost factors associated with the product from each supplier of the plurality of suppliers in order to determine a base per unit cost of the product for each supplier. In certain embodiments, the quality module 206 receives 510 one or more quality factors associated with the product in order to determine a per unit quality price adder for each supplier. In certain embodiments, the quality factors include field quality costs, such as costs associated with product returns, costs of labor, costs of warranties, or the like. Other quality costs may include carrying costs, product insurance costs, shipping costs, customer service costs, or the like. In further embodiments, the quality cost factors include logistical costs (e.g., shipping costs to send new processors), field labor costs (e.g., costs associated with sending personnel to repair or replace the processor), insurance costs, or the like. In one embodiment, the cost module 208 calculates 512 a per unit procurement cost of the product for each supplier of the plurality of suppliers based on the base per unit cost and the per unit quality cost adder.

The supplier module 210, in a further embodiment, receives 514 one or more production factors from each supplier of the plurality of suppliers that describe a supplier's ability to provide the product. In certain embodiments, the production factors include supplier specific factors that may affect whether the supplier can provide the product, how much of the product the supplier can supply, or the like, such as capacity constraints, order lead times, production yields, minimum/maximum order requirements, geographic considerations, and/or the like.

In certain embodiments, the social module 212 monitors 516 one or more social media networks for social data describing one or more events related to a supplier's ability to provide the product. In certain embodiments, the events that may affect the supplier's ability to provide the product include natural disasters, geopolitical unrest events, military events, terrorism events, financial crises, and/or the like. In certain embodiments, the social module 212 monitors 518 one or more RSS feeds that it is subscribed in order to discover information for events related to a supplier's ability to provide the product. In a further embodiment, the social module 212 monitors 520 hashtag data associated with social media for indications of events related to a supplier's ability to provide the product.

In a further embodiment, the social module 212 monitors 522 product-related websites by using a web crawler to search the websites for social data related to the product and/or a product supplier. For example, the social module 212 may use a web crawler to search websites for customer ratings or reviews related to the product. In one embodiment, the social module 212 monitors 524 government websites by using a web crawler to search the websites of governmental organizations associated with the plurality of suppliers. In certain embodiments, the social module 212 receives social data including regulatory information, such as new and existing laws, proposed legislation, public notices, court decisions, and/or the like that may affect a supplier's ability to provide the product.

In one embodiment, the procurement module 214, determines 526, based on the per unit procurement cost of the product, the production factors, and the social data, a product order allocation for each supplier of the plurality of suppliers that fulfills the determined demand. In a further embodiment, the trend module 308 determines 528 trends for each of the cost factors, quality factors, production factors, and social data associated with each supplier. For example, if the number of returns for products produced by supplier A has steadily increased over the past twelve months, even though it may still be in an acceptable range, the procurement module 214 may exclude supplier A from the order allocation until the number of returns for supplier A stops trending upward. The procurement module 214 may update the determined order allocation based on the trending data.

In a further embodiment, the procurement module 214 updates 530 the order allocation based on historical data maintained by the history module 306. The historical data related to suppliers may include special product or supplier considerations, previous supply issues (e.g., delays, warranties, returns, etc.), ease to work with in the past, average lead time, average shipping time, or the like. In some embodiments, the procurement module 214 updates 530 the order allocation based on customer input. For example, the update module 302 may update 530 the order allocation according to a customer's preference for one or more suppliers. For example, the procurement module 214 may have determined that supplier A should fulfill 50% of the order and supplier B should fulfill the other 50% of the order. However, the update module 302 may adjust the order allocation by replacing supplier B with supplier C and increasing supplier's C allocation to 75% in response to the customer's preference for supplier C, and the method 500 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a demand module that determines a demand for a product offered from a plurality of suppliers;
a pricing module that receives one or more cost factors associated with the product from each supplier of the plurality of suppliers, wherein a base per unit cost of the product for each supplier is determined based on the one or more cost factors;
a quality module that receives one or more quality factors associated with the product, wherein a per unit quality cost adder for each supplier of the plurality of suppliers is determined based on the one or more quality factors;
a cost module that calculates a per unit procurement cost of the product for each supplier of the plurality of suppliers based on the base per unit cost and the per unit quality cost adder;
a supplier module that receives one or more production factors from each supplier of the plurality of suppliers, the one or more production factors describing a supplier's ability to provide the product;
a social module that monitors one or more social media networks for social data describing one or more events related to a supplier's ability to provide the product; and
a procurement module that determines, based on the per unit procurement cost of the product, the production factors, and the social data, a product order allocation for each supplier of the plurality of suppliers that fulfills the determined demand;
wherein said modules comprise one or more of hardware and executable code, the executable code stored on one or more computer readable storage media.

2. The apparatus of claim 1, wherein the social module further subscribes to one or more rich site summary (RSS) feeds and monitors the one or more RSS feeds for events related to a supplier's ability to provide the product.

3. The apparatus of claim 1, wherein the social module further searches hashtag data associated with one or more social networks, the hashtag data indicating events related to a supplier's ability to provide the product.

4. The apparatus of claim 1, wherein the social module further receives social data related to a predefined geographic location associated with a supplier of the plurality of suppliers, the social data for the geographic location comprising information related to the supplier's ability to provide the product.

5. The apparatus of claim 4, wherein the social data comprises information related to one or more events in the geographic location, the one or more events comprising:
a natural disaster;
a geopolitical unrest event;
a military event;
a terrorism event; and
a financial crisis event.

6. The apparatus of claim 4, wherein the geographic location comprises a geographic location for one or more of a supplier's headquarters, shipper, distributor, assembly plant, manufacturing facility, and warehouse.

7. The apparatus of claim 1, wherein the social module further uses a web crawler to search one or more websites for data comprising one or more customer ratings related to the product offered by the plurality of suppliers, the procurement module selecting a supplier of the plurality of suppliers based at least in part on the customer ratings, the customer ratings comprising one or more of product ratings, warranty service ratings, customer service ratings, and customer satisfaction ratings.

8. The apparatus of claim 1, wherein the social module further uses a web crawler to search one or more websites of governmental organizations associated with the plurality of suppliers, the social data comprising regulatory information related to a supplier's ability to provide the product.

9. The apparatus of claim 1, further comprising an update module that adjusts the determined product order allocation according to a customer's preference for one or more suppliers of the plurality of suppliers.

10. The apparatus of claim 1, further comprising an exclusion module that maintains a blacklist of one or more suppliers that are not granted an order allocation, a supplier being blacklisted based on one or more factors associated with the supplier not being within a predetermined threshold related to supplying the product for a predefined period of time.

11. The apparatus of claim 1, further comprising a history module that maintains one or more historical factors related to the plurality of suppliers, wherein the procurement module further determines a product order allocation based at least in part on the historical factors, the one or more historical factors determined based on previous transactions with the plurality of suppliers.

12. The apparatus of claim 1, further comprising a trend module that determines trends for each of the cost factors, quality factors, production factors, and social data associated with each supplier of the plurality of suppliers, wherein the procurement module adjusts the product order allocation according to the trends.

13. The apparatus of claim 1, wherein the one or more quality factors comprise a number of customer complaints received for a product offered by a supplier of the plurality of suppliers, the procurement module adjusting the product order allocation in response to the number of customer complaints such that an allocation of products ordered from the supplier is reduced.

14. The apparatus of claim 1, wherein the per unit quality cost adder for each supplier of the product is determined based on one or more of:
costs associated with returns;
costs associated with warranties;
costs associated with labor;
costs associated with shipping;
costs associated with insurance; and
costs associated with product repair.

15. The apparatus of claim 1, wherein the one or more production factors for each supplier of the plurality of suppliers comprises one or more of:
a production yield;
an order lead time;
a manufacturing capacity; and
a minimum order quantity.

16. A method comprising:
determining a demand for a product offered from a plurality of suppliers;
receiving one or more cost factors associated with the product from each supplier of the plurality of suppliers, wherein a base per unit cost of the product for each supplier is determined based on the one or more cost factors;
receiving one or more quality factors associated with the product, wherein a per unit quality cost adder for each supplier of the plurality of suppliers is determined based on the one or more quality factors;
calculating a per unit procurement cost of the product for each supplier of the plurality of suppliers based on the base per unit cost and the per unit quality cost adder;
receiving one or more production factors from each supplier of the plurality of suppliers, the one or more production factors describing a supplier's ability to provide the product;
monitoring one or more social media networks for social data describing one or more events related to a supplier's ability to provide the product; and
determining, based on the per unit procurement cost of the product, the production factors, and the social data, a product order allocation for each supplier of the plurality of suppliers that fulfills the determined demand.

17. The method of claim 16, wherein further comprising receiving social data related to a predefined geographic location associated with a supplier of the plurality of suppliers, the social data for the geographic location comprising information related to the supplier's ability to provide the product.

18. The method of claim 17, wherein the social data comprises information related to one or more events in the geographic location, the one or more events comprising:
a natural disaster;
a geopolitical unrest event;
a military event;
a terrorism event; and
a financial crisis event.

19. The method of claim 16, further comprising using a web crawler to search one or more websites for data comprising one or more customer ratings related to the product offered by the plurality of suppliers, the procurement module selecting a supplier of the plurality of suppliers based at least in part on the customer ratings, the customer ratings comprising one or more of product ratings, warranty service ratings, customer service ratings, and customer satisfaction ratings.

20. A computer program product for product procurement, the computer program product comprising a computer readable storage medium having program instructions embodied therewith, the program instructions readable/executable by a processor to cause the processor to:
determine a demand for a product offered from a plurality of suppliers;
receive one or more cost factors associated with the product from each supplier of the plurality of suppliers, wherein a base per unit cost of the product for each supplier is determined based on the one or more cost factors;
receive one or more quality factors associated with the product, wherein a per unit quality cost adder for each supplier of the plurality of suppliers is determined based on the one or more quality factors;
calculate a per unit procurement cost of the product for each supplier of the plurality of suppliers based on the base per unit cost and the per unit quality cost adder;
receive one or more production factors from each supplier of the plurality of suppliers, the one or more production factors describing a supplier's ability to provide the product;
monitor one or more social media networks for social data describing one or more events related to a supplier's ability to provide the product; and
determine, based on the per unit procurement cost of the product, the production factors, and the social data, a product order allocation for each supplier of the plurality of suppliers that fulfills the determined demand.
